(19) United States
(12) Patent Application Publication
(10) Pub. No.: US 2012/0058392 A1
(43) Pub. Date: Mar. 8, 2012

(54) Rechargeable battery with aluminium anode, graphite cathode and an electrolyte containing aluminium vapour in plasma state

(76) Inventor: Pedro Manuel Brito da Silva Correia, Estoril (PT)

(21) Appl. No.: 12/876,143

(22) Filed: Sep. 5, 2010

(51) Int. Cl. H01M 10/02

(52) U.S. Cl. 429/188

(57) ABSTRACT

We propose a rechargeable battery with aluminium anode. In order to avoid the high reactivity of aluminium ions with most liquid electrolytes, we present an electrolyte containing aluminium vapour in plasma state.

The battery is contained in a quartz cylinder heated with microwaves to a sufficiently high temperature to ionise the aluminium ions in the vapour.

The anode is graphite. By receiving electrons from the external circuit, carbon atoms in the graphite hexagonal structure receive 1 or 2 or 3 negative charges and combine with aluminium ions from the electrolyte. Four charges in the carbon atom corresponds to Al₄C₃, aluminium carbide, which can also be found. It has a melting point of 2100° C., it is a solid at the plasma temperature and sticks to the anode.

### 1. FIELD OF INVENTION

Rechargeable batteries with aluminium anode, plasma electrochemistry of aluminium vapour

### 2. BACKGROUND OF THE INVENTION

Environment concerns on fossil fuels which increase the carbon oxide concentration in the atmosphere, economic concerns on the increasing costs of exploring fossil fuels, political concerns on the social stability of the countries where the fossil fuels are located, stimulated research on alternative sources of energy. The most convenient way to transport energy is by converting primary renewable energy sources into electricity, which can be easily transported by metal cables.

The supply of electric energy for transports like cars and trucks has the difficulty of finding a device which is cheap, and presents a sufficiently large capacity per unit of weight for storage of electricity.

The Argonne laboratories filed several patents on batteries using an aluminium anode and an aqueous electrolyte. They present a big storage capacity per unit weight, they are inexpensive and they are in use for transportations in cars of the US Army.

However, these batteries are not rechargeable.

The difficulty to make aluminium anode batteries rechargeable is the fact that aluminium appears almost exclusively as an ion with 3 positive charges, which corresponds to an ionisation energy of about 60 eV. In aqueous electrolytes, the bond Al—O is almost covalent, and needs a lot of energy to be broken. This is the reason why the aluminium production from the ore bauxite (aluminium oxide), is so energy consuming.

We tried to use non aqueous electrolytes, like ionic liquids, tetrafluorborates, hexafluorphosphates, Bis (trifluoromethylsulfono)imide but always came to an unstable quickly falling tension discharge curves, caused by side reactions of aluminium ions with the electrolytes and changes in the surface of the aluminium electrode.

We looked into literature on plasma electrochemistry, but did not find any application to aluminium batteries. Aluminium vapour in plasma state would avoid any problems with undesirable side reactions of aluminium with the electrolyte.

### 3. DETAILED DESCRIPTION OF THE INVENTION

We are now proposing an electrolyte composed of ionized aluminium vapour. We consider following physical properties for aluminium:

Melting point 660° C.

Boiling point 2467° C.

Vaporization enthalpy 293.7 kJ/mole

Ionization enthalpy 6200 kJ/mole=62 eV

Vapour pressure at 1217° C.=1.33 pascal

The container for the electrolytic cell is quartz, which has a melting point of 1710° C.

The anode is graphite, which has a melting point of 3550° C.

The cell itself is a cylinder with round bottoms for supporting pressure with the axis in a vertical position. This cell is heated by microwaves created by an external coil.

The aluminium electrode is down and connected by a wire to the exterior circuit.

The graphite electrode is in the top, connected by a wire to the exterior.

A quartz pipe with 5 mm diameter and a valve is welded to the middle of the quartz cylinder and is used to make a vacuum of 10-6 pascal before heating.

After reaching a temperature of about 1000° C. we applied a voltage of 10 Volt in order to load the cell by transferring aluminium atoms from the aluminium electrode to the plasma and from the plasma the aluminium ions are transferred to the graphite electrode.

After one hour loading, we stopped. Then we could measure a voltage of 5.6 Volt, stable during one hour. Further work is in progression.

### EXAMPLE

We built a quartz cylindric ampoule with round tops with 30 mm diameter, 60 mm length, 5 mm thickness. Before welding on of the tops, we introduced in the bottom 5 g of aluminium granules connected to the outside with a tungsten wire with 2 mm diameter.

In the top of the ampoule with built a porous graphite electrode with 10 mm diameter and 10 mm length connected also by, a tungsten wire with 2 mm diameter to the outside of the ampoule.

We welded the upper top and made vacuum of 1 pascal.

We introduced the ampoule in a microwave furnace and heated up to 1200° C.

We applied an exterior continuous tension of . 10 volt during one hour. Then we stopped and measured the discharge tension during one hour. It was quite constant at 5.6 Volt.

### BIBLIOGRAPHY

1. U.S. patent Ser. No. 12/484,214
2. U.S. patent Ser. No. 12/700,888
3. Electrochemistry Communications, 4/(2002) 780-786, Daren J. Carnane, Sean P. McCormack

1. A rechargeable battery with aluminium anode, graphite cathode and an electrolyte containing aluminium vapour in plasma state and its application for energy storage

2. In the product of claim 1 where the purity of the aluminium anode may be 99.5 to 99.9999

3. In the product of claim 1 where the aluminium anode can be doped to improve its properties with small quantities of metals or metalloids, which may be but are not limited to selen, zinc, beryllium.

4. In the product of claim 1 where the form of the electrodes and the geometry of the electrolyte space can be adapted to the needs of the application and may therefore contain electrodes as rods, sheets, plane or cylindrical and the distances between electrodes may vary from 0.1 to 10 mm.

5. In the product of claim 1 where the temperature of the plasma electrolyte and the electrodes is increased by using microwave coils, where the temperature of aluminium ions and electrons may differ from each other and vary from the melting point up to the boiling point of aluminium at the ampoule pressure.

6. In the product of claim 1 where the electrodes and the electrolyte are contained in a quartz ampoule at a pressure measured at room temperature of 10⁻⁹ up to 10⁻⁶ bar.
